(19) United States
(12) Patent Application Publication
(10) Pub. No.: US 2015/0320056 A1
(43) Pub. Date: Nov. 12, 2015

(54) DOUGH PRODUCTS HAVING AN OPEN-CELL STRUCTURE AND METHODS FOR MAKING SAME

(71) Applicant: NESTEC S.A., Vevey (CH)

(72) Inventor: Frank Arthur Cole, Glenview, IL (US)

(73) Assignee: NESTEC S.A., Vevey (CH)

(21) Appl. No.: 14/367,648

(22) PCT Filed: Dec. 12, 2012
(86) PCT No.: PCT/EP12/75194

§ 371 Date: Jun. 20, 2014

Related U.S. Application Data
(60) Provisional application No. 61/578,581, filed on Dec. 21, 2011.

(51) Int. Cl. A21D 8/04; A21D 8/06

(52) U.S. Cl. CPC A21D 8/042; A21D 8/06

(57) ABSTRACT

The present disclosure relates to dough and dough-based food products having a unique appearance and texture. In a general embodiment, a dough is provided and includes at least one enzyme having an enzyme activity level sufficient to provide the dough with at least one characteristic selected from the group consisting of a water absorption ranging from about 58% to about 64%, a fermentation after about 90 minutes, retention of gas cells after sizing and/or baking the dough, good viscoelastic properties after baking the dough, or combinations thereof. The dough may also include the use of a specifically sourced malted barley flour at a level that is not recommended by the baking industry and/or processing parameters that reduce the fermentation time of the dough. Methods for making a dough are also provided.

### BACKGROUND

The present disclosure relates generally to food technologies. More specifically, the present disclosure relates to dough and dough products having improved characteristics and methods for making same.

Processes used to manufacture baked goods have been known for centuries, although it is not always easy to obtain a baked good having certain desired characteristics that can be produced in a timely manner. To achieve a specific characteristic of a baked good, a delicate balance of the proper ingredients and baking processes are required. However, not all ingredients used to make baked goods are inherently the same. For example, one batch of a specific flour may react undesirably in a baked dough when provided at a specific amount. Alternatively, a different batch of the same flour may react desirable in the baked dough when provided at the same amount. Such discrepancies in ingredients can make the baking process an inconsistent science.

Once the baker has assembled the proper list of ingredients the baking process then requires a certain amount of time, the proper equipment, and the proper baking parameters to arrive at the desired baked good. Therefore, a need exists for baked goods having desirable characteristics that may be prepared in a time-efficient manner.

### SUMMARY

The present disclosure provides dough and dough-based food products and methods for making same. In an embodiment, a dough is provided that includes at least one enzyme having an enzyme activity level from about 80° Litner to about 110° Litner, wherein the enzyme level provides the dough with at least one characteristic selected from the group consisting of medium to high water absorption, medium fermentation time of about 80 to about 100 minutes, retention of gas cells after sizing the dough, or combinations thereof, wherein the dough is not baked.

In an embodiment, the dough comprises a water absorption from about 58% to about 65%.

In an embodiment, the dough comprises a medium fermentation time of about 90 minutes.

In another embodiment, a dough is provided that includes at least one enzyme having an enzyme activity level from about 80° Litner to about 110° Litner, wherein the enzyme level provides the dough with at least one characteristic selected from the group consisting of retention of gas cells after baking the dough, good viscoelastic properties after baking the dough, or combinations thereof.

In an embodiment, wherein the good viscoelastic properties of the dough allow the dough to flow and to maintain a shape without deforming to an original shape or shrinking.

In an embodiment, the at least one enzyme is selected from the group consisting of α-amylase, β-amylase, γ-amylase, protease, or combinations thereof. The at least one enzyme may have an enzyme activity level from about 80° Litner to about 110° Litner. In an embodiment, the at least one enzyme has an enzyme activity level of about 95° Litner.

In an embodiment, the dough includes malted barley flour in an amount from greater than 1% to about 5% by flour weight.

In an embodiment, the dough further includes at least one ingredient selected from the group consisting of flour, water, salt, sugar, yeast, or combinations thereof.

In yet another embodiment, a dough is provided and includes malted barley flour in an amount greater than 1% to about 5% by flour weight. The dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, or combinations thereof.

In an embodiment, the dough includes malted barley flour in an amount greater than 1% to about 3% by flour weight. The dough may also include malted barley flour in an amount of about 1.5% by flour weight.

In an embodiment, the dough further comprises at least one ingredient selected from the group consisting of flour, water, salt, sugar, yeast, oil, or combinations thereof.

In an embodiment, the malted barley flour comprises at least one enzyme selected from the group consisting of α-amylase, β-amylase, γ-amylase, protease, or combinations thereof.

In an embodiment, the at least one enzyme has an enzyme activity level from about 80° Litner to about 110° Litner. The at least one enzyme may also have an enzyme activity level of about 95° Litner.

In still yet another embodiment, a method of making a dough-based food product is provided. The method includes mixing a dough having malted barley flour in an amount greater than 1% to about 5.0% by flour weight, fermenting the dough for an amount of time between about 60 and about 120 minutes, and baking the dough to form the dough-based food product. The dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, or combinations thereof.

In an embodiment, the malted barley flour comprises at least one enzyme selected from the group consisting of α-amylase, β-amylase, γ-amylase, protease, or combinations thereof.

In an embodiment, the at least one enzyme has an enzyme activity level from about 80° Litner to about 110° Litner. The at least one enzyme may also have an enzyme activity level of about 95° Litner.

In an embodiment, the dough is fermented for about 90 minutes.

In an embodiment, the dough is baked at an oven temperature from about 300° F. to about 800° F. The dough may be baked at an oven temperature of about 600° F.

In an embodiment, the method further includes at least one step selected from the group consisting of sizing the dough into a dough billet after fermenting the dough, proofing the dough after sizing the dough, applying a dusting flour to the dough after pressing the dough, packaging the dough-based food product, or combinations thereof.

In still yet another embodiment, a method of making a dough-based food product is provided. The method includes mixing a dough having at least one enzyme having an enzyme activity level sufficient to provide the dough with at least one characteristic selected from the group consisting of medium to high water absorption, medium fermentation time of about 90 minutes, retention of gas cells after sizing and/or baking the dough, good viscoelastic properties after baking the dough, or combinations thereof. The method further includes fermenting the dough for an amount of time between about 60 and about 120 minutes, and baking the dough to form the dough-based food product.

The skilled artisan will appreciate that any combination of claims and/or embodiments disclosed herein are supported by the present disclosure and that the subject matter disclosed herein should not be limited to the claims as filed.

Additional features and advantages are described herein, and will be apparent from the following Detailed Description and the figures.

### BRIEF DESCRIPTION OF THE FIGURES

FIG. 1 shows a perspective view of a dough product in accordance with an embodiment of the present disclosure.

FIG. 2 shows a cross-section of the dough product of FIG. 1 along line II-II in accordance with an embodiment of the present disclosure.

### DETAILED DESCRIPTION

This application is related to and incorporates by reference, commonly assigned, co-pending U.S. Appl. Ser. No. 61/578,574 (Attorney Docket No. 3712036-01429) entitled, “FOOD PRODUCTS HAVING A HAND-MADE, TEXTURED APPEARANCE AND METHODS FOR MAKING SAME.”

In a general embodiment, a dough is provided that includes at least one enzyme having an enzyme activity level sufficient to provide the dough with at least one characteristic selected from the group consisting of medium to high water absorption, medium fermentation after about 90 minutes, retention of gas cells after sizing and/or baking the dough, good viscoelastic properties after baking the dough, or combinations thereof. These characteristics help to achieve a dough having open-cell structure final attributes that are typical of baked goods that require higher water absorption and longer fermentation periods. Ingredients and processing parameters necessary to prepare such a dough, however, are not immediately apparent. Applicants have surprisingly found that by providing specific enzymes in specific amounts, certain desirable characteristics of baked goods can be achieved.

Applicants have also found that one manner in which to achieve the improved enzyme activity is through the use of specifically sourced malted barley flour having a specific enzymatic activity at a level not recommended by the baking industry to deliver the correct amount of enzymatic activity. Further, Applicants have found that using the specifically sourced malted barley flour in conjunction with a specific baking process provides baked goods having open-cell structure final attributes that are typical of baked goods that require higher water absorption and longer fermentation periods. This is beneficial because processing parameters such as higher water absorption and longer fermentation periods are not without their drawbacks.

For example, existing solutions for fermentation time involve allowing dough enough time to naturally ferment and gas at a slower rate so that larger more open grain can be achieved. The drawback to allowing dough to naturally ferment can be seen in, for example: (i) not having the time and/or availability to rest dough; (ii) not having the space required to rest large batches of dough; and (iii) not having the capability to manage each batch of mixed dough in large-scale production.

Existing solutions for high water absorption include providing dough that is hydrated above the optimum level of water absorption so as to reduce the ability of the dough to stabilize smaller, more regularly sized air cells. Instead, the air cells coalesce and great larger, non-uniform gas cells often referred to as open grained or open cell structure are formed. However, the drawbacks to adding higher amounts of water to dough can include, for example: (i) the dough becomes very sticky and/or tacky and is difficult to process; and (ii) more time is required for flour to fully hydrate and develop.

The present disclosure solves the problem(s) of not having the time and/or processing capability to rest dough or to mix and process dough with higher amounts of water. Additionally, the present disclosure is able to provide dough having certain desirable characteristics including, for example, a medium-to-high water absorption, the capability of being sheeted to a thickness of about 8 mm, and a medium fermentation after about 60 to 120 minutes, or 90 minutes, of lay time. The dough is also able to maintain gas cells through the sizing process such that after pressing the dough is capable of producing a finished baked product that has medium browning, is light on the palate, and has an airy, open-air cell structure (e.g., irregular gas cells). Note that while an open-air structure is created, it is a stable cell structure in the dough such that air cells do not coalesce to an extent that it creates an undesirable product. Typically, open cell structure is obtained through longer fermentation time, increase amounts of water, or combinations thereof. Applicants have surprisingly found that use of increased amounts of malted barley flour and specific processing steps can be used to create desired attributes such as, for example, open grain/cell structure without the excessively long fermentation or high water absorption.

More specifically, the present products and methods include the use of flours (e.g., malted barley flour) with high enzymatic activity in the dough formula at a rate that is much higher than typically used in the baking industry. This ingredient alone or in conjunction with a reduced resting period of from about 60 to 120 minutes, or 90 minutes, creates dough that is possible to process using industrial manufacturing equipment. The dough formulations of the present disclosure provide advantages over known dough formulations, for example, because the amount of malted barley flour included in the present dough formulations is outside the level recommended by the baking industry. Applicants believe that there currently exists no product on the market that incorporates malted barley flour outside of the levels recommended by the malt and baking industries (e.g., typically 0-1.0%). The use of malted barley flour at this level aids in supplementing the enzymes present in flour to condition the dough through improved fermentation and starch pasting. Using levels higher than the 0-1.0% is typically avoided as it can have a reverse affect on dough functionality causing unwanted dough characteristics such as, for example, softness and gumminess, which make the dough difficult to process.

Further, embodiments of the dough formulations of the present disclosure include diastatic malted barley as an enzyme source, which aids in improving flour quality. The additional enzymatic activity offered by the malted barley flour also assists in breaking down starch to provide sugar for yeast fermentation, which provides benefits including, for example, improved color, flavor, dough flow processing, and volume. The specifically sourced malted barley flour of the present disclosure may have at least one enzyme selected from the group consisting of α-amylase, β-amylase, γ-amylase, protease, or combinations thereof. The enzyme may have an enzyme activity level from about 80° Litner to about 110° Litner. The at least one enzyme may also have an enzyme activity level of about 95° Litner.

At least in part due to the enzyme activity, the dough formulations of the present disclosure exhibit desirable characteristics such as, for example, a medium-to-high water absorption, a medium fermentation after about 90 minutes of lay time, the ability to maintain gas cells when sheeted to a thickness from about 6 to 10 mm, or 8 mm, medium browning after baking, an open cell structure after baking, and good viscoelastic properties after baking. Indeed, the baked crust exhibits an interior crumb that has expanded and raised, thereby providing a soft, bready interior compared to the more typical, dense crumb of a par-baked crust. Malted barley flour can further help the dough to retain a sufficient amount of elasticity to allow the dough to return to its original shape after being compressed, yet still create a desired final dough product shape of, for example, a loaf, bagel, or pizza.

Most dough based products are hydrated based upon the flours ability to take on water in conjunction with other hygroscopic ingredients within the dough. Most American bread flours possess absorptions in the range of 58-64% water based on weight. Dependant on the style of baked product, more or less water is used. For example, pizza doughs are typically on the lower side 50-58% absorption, whereas pan breads are in the medium or optimal absorption 58%-64%. Artisanal breads are likely above this range 65% and much higher. At the end of the day the water absorption of a dough is dependent on the strength and quality of the flour and other ingredients in the dough. As used herein, a “medium-to-high” water absorption refers to a water absorption between about 50% and about 80%, or from about 60% to about 70%, or about 65%, or from about 50% to about 65%, or from about 58% to about 64%, or from about 55% to about 60%, or about 55%, about 56%, about 57%, about 58%, about 59%, about 60%, about 61%, about 62%, about 63%, or about 64%.

As used herein, a “medium fermentation” refers to a fermentation time from about 1 hour to about 4 hours, or from about 1 hour to about 3 hours, or about 2 hours or about 1.5 hours. A low fermentation time would be approximately one hour, or from about 0.5 hours to about 1 hour. A long fermentation time would be about 3.5 to 4 hours or longer.

Further, as used herein, “good viscoelastic properties” means that the baked dough has the ability to flow (i.e., be pressed into the shape of the die) while also maintaining the elasticity to hold shape without snapping back to an original shape or excessively shrinking.

The dough of the present disclosure may be, for example, white bread dough, hearth bread dough, dark bread dough, sweet bread dough, roll dough, cracker dough, bagel dough, biscuit dough, pizza dough, whole grain dough, flat bread dough, pita dough, or combinations thereof. The dough of the present disclosure may also include ingredients found in typical dough products. For example, the dough may also include flours such as wheat flour, corn flour, or multigrain flour, water, salt, sugar, oil, yeast, shortening, flavoring, baking powder, enzymes, etc. In an embodiment, the dough includes wheat flour, water, salt, sugar, oil, yeast and malted barley flour. The malted barley flour, however, is provided in an amount that is not typically used for dough products, as is discussed above. For example, in the present products, malted barley flour may be provided in an amount from about 0.5% to about 5.0%, or from about 1% to about 4%, or from about 2% to about 3%. In an embodiment, malted barley flour may be provided in an amount greater than about 1% to about 3%, or greater than about 1% to about 2.5%, or greater than about 1% to about 2%, or about 1.5%. In an embodiment, malted barley flour may be provided in an amount from about 1.5% to about 3%, or from about 1.5% to about 2.5%, or from about 1.5% to about 2%. In an embodiment, malted barley flour may be provided in an amount from about 2% to about 3%, or from about 2.5% to about 3%.

As discussed above, the use of increased amounts of malted barley flour provides several advantages for the dough of the present disclosure. For example, increased amounts of malted barley flour helps to provide a dough that has a medium-to-high water absorption, a medium fermentation after about 90 minutes of lay time, the ability to maintain gas cells when sheeted or processed to a thickness from about 6 to 10 mm, or 8 mm, medium browning after baking, and an open cell structure after baking. As discussed above, these attributes are more typical of dough that requires an extended fermentation time period (e.g., fermentation periods in excess of three hours) and high water absorption.

The malted barley flour of the present dough also has high enzymatic activity that reacts at a rate that is much higher than is typically used in the baking industry. Using increased amounts of such malted barley flour, in combination with specific processing steps, which will be described in further detail below, creates dough that exhibits open-cell structure that is typical of baked goods that require higher water absorption and longer fermentation periods.

As used herein, “open cell structure” refers to voids or open cells in a dough that can affect the density and elasticity of the dough when baked. The voids or open cells inside dough portion 12 may form for different reasons, some of which include, for example, yeast inside the bread, which, when being made, can convert starches or carbohydrates in the dough to create air, or a pocket of air trapped within the bread. Open cell structure may be characterized visually, as well as in in-mouth texture by the term “aerated,” which is defined as the amount of air in the dough product overall. The term “blisters” is sometimes used to refer to amounts of large air bubbles on the surface of products. Open cell structure of a dough-based product is also related to the density of the product, which is defined as the measure of the compactness of the product ranging from light/airy to compact/dense. Additionally, open cell structure may be discussed in terms of elasticity of the food product, or springiness of the product, which is the degree to which the product returns to its original shape after being compressed. The size and count of the individual air cells can be measured using known scanning equipment.

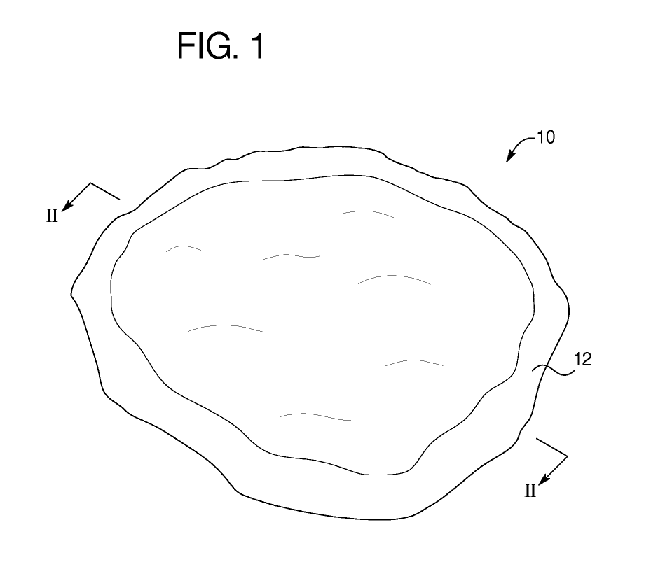

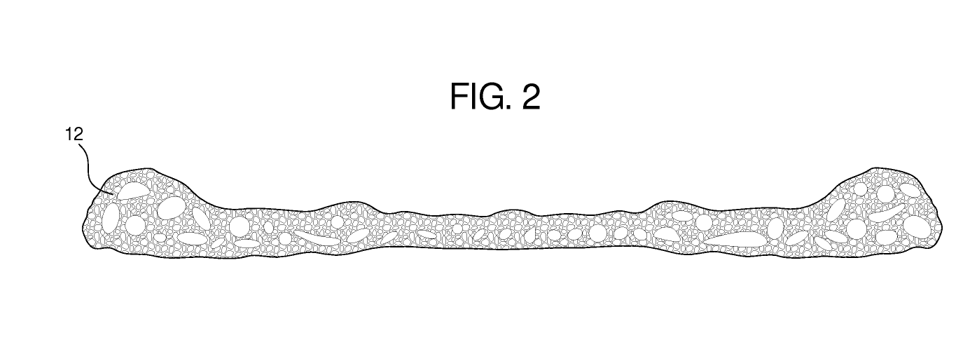

For example, and referring now to FIG. 1, a dough or dough product 10 may be provided having a dough portion 12. As can be seen in the cross-sectional view in FIG. 2, dough portion 12 has an open cell structure that comprises a plurality of voids or open cells that can be characterized visually. This open cell structure is typical of baked goods that require higher water absorption and longer fermentation periods.

In addition, other processing parameters can offer advantageous characteristics to the products of the present disclosure. For example, the dough of the present disclosure does not require extended fermentation times typical of baked goods (e.g., at least three hours). Instead, the dough of the present disclosure may be fermented (e.g., lay time) for a period of time from about 60 to about 120 minutes, or about 90 minutes, which is much less than the typical fermentation time of at least three hours. Indeed, some prior art processes require fermentation times of up to 8 to 24 hours. During lay time or fermentation time of the dough, the dough may rest in an environment having a temperature from about 60° F. to about 90° F., or from about 70° F. to about 80° F., or about 75° F.

Additional processing steps may include, for example, mixing dough having a higher level of malt flour containing amylase and protease enzymes; allowing 60-120, or 90 minutes lay time/fermentation time; sizing dough into a dough billet; proofing the dough; pressing the dough with a unique die having an irregular shape; applying light dusting flour; oven-baking the dough at an oven temperature between about 300° F. and about 800° F., or about 600° F., or about 700° F., depending on the type of dough being baked; packaging the dough-based food product, or combinations thereof. Note that the temperature refers to the temperature in the oven or heating apparatus, not the temperature of the dough. Additionally, the skilled artisan will appreciate that a white bread, for example, will be baked at an oven temperature that is lower than an oven baking temperature for, for example, a pizza dough.

Further processing steps may include, for example, sizing of the dough. As used herein, “sizing” the dough refers to a process by which a large body of dough is formed into at least two smaller dough bodies that may be pressed by a die press to form a final dough piece for baking. Different “sizing” processes that may be used in the present processing steps include, but are not limited to, sheeting, dividing a dough mass into dough balls, cutting a dough mass, dividing a dough mass into a plurality of pieces, etc.

The dough of the present disclosure may also be proofed during processing and the skilled artisan will understand that the proofing conditions will depend on the type of dough being proofed. In an embodiment, the dough may be proofed at a temperature from about 80° F. to about 120° F., or from about 90° F. to about 110° F., or at about 100° F. The proofing may be for an amount of time from about 10 to about 40 minutes, or from about 20 to 30 minutes, or about 25 minutes. Further, the proofing may be performed at a relative humidity from about 30% to about 60%, or from about 40% to about 50%, or about 45%.

The skilled artisan will appreciate, however, that the processing described above are embodiments of a process used to make products of the present disclosure and that the exemplary steps set forth in this Example may be modified without departing from the intended advantages of the processes set forth herein.

By using a process that is similar to the process set forth herein, Applicants are able to provide a dough that exhibits characteristics of a dough that would otherwise require a much longer process to create, and/or the addition of large amounts of water. Indeed, the combination of the present dough formulations and processing parameters having a reduced fermentation time can provide a dough that exhibits open-cell structure final attributes that are typical of baked goods that require higher water absorption and longer fermentation periods.

In an embodiment, the present disclosure relates to the combination of a specifically sourced malted barley flour of approximately 95 degrees Litner at a level higher than what the baking industry recommends with a process including 90 minutes of fermentation time. The combination of malted barley flour and fermentation time gives the enzymes present in the malted barley flour the ability to condition the dough to the point that, when baked, the finished baked good maintains an open cell structure.

The benefits of the malted barley flour over what is previously known is that when other malted barley flours of similar diastatic activity are used at elevated rates it causes the breakdown of starch and protein found in flour. This forfeits the ability for dough to capture and maintain gas cells. In contrast, when the malted barley flour of the present disclosure is applied in dough and given a 90 minute fermentation time it properly conditions the dough and allows for an open cell-structure more typical of doughs produced by long fermentation times and high water absorption. This advantageously eliminates the need for high water absorption in dough and the need to ferment dough longer than 90 minutes.

By way of example and not limitation, the following examples are illustrative of various embodiments of the present disclosure. The formulations and processes below are provided for exemplification only, and they can be modified by the skilled artisan to the necessary extent, depending on the special features that are desired.

### Example 1

### Use of a Specifically Sourced Malted Barley Flour

Applicants tested several different malted flours from barley, wheat and sprouted wheat sources from different suppliers to determine which type of malted flour provided the desired characteristics described herein above (e.g., open cell structure with 90 or less minutes of fermentation time, etc.). A list of tested malted flours include:

Flour #1—A standard malted barley flour (enzyme activity unknown)

Flour #2—A standard malted barley flour (enzyme activity unknown)

Flour #3—A whole grain malted barley flour (diastatic activity of 200° Litner)

Flour #4—Munich 10L malted barley flour (diastatic activity of 30° Litner)

Flour #5—whole grain malted wheat flour (diastatic activity of 170° Litner)

Flour #6—sprouted wheat flour toasted medium (nondiastatic)

Flour #7—maltorose dough improver (diastatic activity of 20° Litner)

Flour #8—malted barley flour (diastatic activity of about 95 or 96° Litner)

Each of the different flours tested by Applicants changed the flavor of the dough in different ways when tested at 2.0% by flour weight. The best flavor with the desired baked goods characteristics was achieved using Flour #8 with a diastatic enzyme activity of about 95 or 96° Litner. Applicants believe that the differences between the flours tested was due to the enzymatic activity of the flour. Potential other differences could be due to a degree to which the flours are toasted or dried, or agricultural differences during growth of the grains.

### Example 2

### Experiments to Characterize Malted Barley Flours

The characteristics of the malted barley flour can be determined using α- and β-amylase testing, through measuring proteolytic activities, and through starch pasting analysis (RVA). Additionally the quality the malted barley flour imparts on a dough or substrate can be determined using objective measurements such as those found using the Farinograph, Extensograph, Rheofermentometer, and the creep recovery and oscillation testing. The characteristics of the final baked dough product may be quantified through crumb grain analysis (C-cell) and sensory measurements. Set forth below are characterizing techniques proposed by Applicants to characterize a specifically sourced malted barley flour and doughs prepared using same.

1. Characterization of Enzyme Activities

1.1 Amylolytic Activities

α- and β-amylase activities may be determined by Ceralpha and Betamyl-3 methods (Megazyme, Wicklow, Ireland) using non-reducing end blocked p-nitrophenyl maltoheptaoside (endo-activity/α-amylases) and p-nitrophenyl maltopentaoside (exo-activity/β-amylases) as substrates. The hydrolysed substrate is cleaved to p-nitrophenyl and glucose by α-glucosidase. The phenolate color is developed under alkalic conditions and the absorbance at 400 nm is measured. One unit of activity corresponds to the liberation of 1 μmol p-nitrophenol min-1 under assay conditions (pH 5.2, T=40 C).

1.2 Proteolytic Activities

Proteolytic activity may be determined using haemoglobin as substrate. The samples are prepared by extracting freshly milled malt flours for 30 minutes at 5° C. in 0.05 M acetate buffer with 2 mM L-cysteine at pH 5.0 (1:10 for the haemoglobin and 1:3 for the azocasein assay). Solids are removed by centrifugation (10,000 g×15 minutes at 4° C.) and the extracts are assayed immediately. 50 μl sample extract and 450 μl 0.2 M acetate buffer (pH 4.0) containing bovine haemoglobin (reaction concentration 0.5%) is incubated for 150 minutes at 40° C. The reaction is stopped with 400 μl cold 10% trichloroacetic acid (TCA) and centrifuged (1,000 g×10 minutes). The free α-amino nitrogen is measured by incubating 25 μl supernatant and 225 μl TNBS for 20 min at 50° C. The reaction is stopped by adding 750 μl HCl (0.2 M) and A₃₄₀ measured against H₂O. A standard curve of L-leucine is used for quantification. One unit of activity corresponds to the enzyme activity that liberates 1 mg leucine/h/g under the assay conditions.

2. Cell Counts

Samples of proofed dough are serially diluted 1:10 with Ringer solution and plated on YGC agar supplemented with chloramphenicol for yeast counts and incubated under aerobic conditions at 28° C., and on PCA agar supplemented with cycloheximide (total count) or VRBL (specific for coliforms) and incubated anaerobically at 30° C. for bacteria.

3. pH and Total Titratable Acidity (“TTA”)

The pH and the TTA of proofed dough are determined from a suspension of 10 g of dough in 90 mL of water. The TTA is expressed as the amount of 0.1 M NaOH to achieve pH 8.5 (with retitrating to pH 8.5 about 3 minutes after it was first reached).

4. Rheological Characterisation of Dough

4.1 Farinograph and Extensograph

Either with

(a.) malt/flour mix according to the official method; or

(b.) all ingredients according to the recipe (recommendable especially if the recipe is complex).

For the Farinograph measurement 300 g flour (a.) on a 14% moisture basis or (b.) ingredients according to the recipe is placed in the mixing bowl. Water is added (a.) to obtain a consistency of 500 BU or (b.) according to the recipe. The mixing is recorded for 15 minutes.

The sample for the extensograph measurement is prepared using the mixing bowl of the Farinograph ((a.) flour/malt/water mixture or (b.) according to the recipe). Two 150 g pieces are cut out and shaped using the extensograph rounder and shaper. The dough pieces are placed in the cradle, secured with pins and allowed to rest in the chambers (T=30° C.) for 90 minutes. After the rest a hook is drawn through the dough and the resistance is measured.

4.2 Oscillation and Creep Recovery Test

Dough samples (all ingredients except yeast) are mixed for 70 seconds with Glutomatic (Falling Number AB, Huddinge, Sweden). The sample is placed in a sealed container with a wet piece of tissue for 10 minutes. After the rest the sample is mounted on a controlled stress rheometer (MCR301, Anton Paar GmbH, Austria) with a cross-hatched parallel plate geometry (50 mm; gap 2 mm) and the edges of the dough are trimmed and covered with a 1:3 mixture of high vacuum grease and heptane. The sample is covered with a chamber lined with a wet strip of cotton wool. The sample is rested between the plates for 80 min (=the duration of proofing) under a small strain and frequency (γ=0.01%, 1 Hz) to allow the normal force to reach >1 N. A creep stress of 250 Pa is applied for 5 minutes followed by a 10 minute recovery phase (τ=0 Pa). All measurements are performed at 30° C.

4.3 Rheofermentometer

Gas formation and retention in fermenting doughs may be determined using a Rheofermentometer F3 (Chopin, Villeneuve la Garenne, France). The doughs are prepared using a Kenwood mixer. 300 g dough is placed in the fermentation vat and a weight of 1.5 kg is placed on top it. The measurement is carried out for 3 hours at 30° C.

5. Results of the Characterization Studies

### Aspects of the Present Disclosure

Aspects of the subject matter described herein may be useful alone or in combination one or more other aspect described herein. Without limiting the foregoing description, in a first aspect of the present disclosure, a dough includes at least one enzyme having an enzyme activity level from about 80° Litner to about 110° Litner, wherein the enzyme level provides the dough with at least one characteristic selected from the group consisting of a water absorption ranging from about 58% to about 64%, a fermentation time from about 80 to about 100 minutes, retention of gas cells after sizing, or combinations thereof, wherein the dough is not baked.

In accordance with a second aspect of the present disclosure, which may be used in combination with the first aspect, the water absorption is about 60%.

In accordance with a third aspect of the present disclosure, which may be used in combination with any one or more of the preceding aspects, the dough comprises a fermentation time of about 90 minutes.

In accordance with a fourth aspect of the present disclosure, which may be used with any one or more of the preceding aspects, the at least one enzyme is selected from the group consisting of α-amylase, β-amylase, γ-amylase, protease, or combinations thereof.

In accordance with a fifth aspect of the present disclosure, which may be used in combination with any one or more of the preceding aspects, the at least one enzyme has an enzyme activity level of about 95° Litner.

In accordance with a sixth aspect of the present disclosure, which may be used in combination with any one or more of the preceding aspects, the dough includes malted barley flour in an amount from greater than 1% to about 5% by flour weight.

In accordance with a seventh aspect of the present disclosure, which may be used in combination with any one or more of the preceding aspects, a dough includes at least one enzyme having an enzyme activity level from about 80° Litner to about 110° Litner, wherein the enzyme level provides the dough with at least one characteristic selected from the group consisting of retention of gas cells after baking, good viscoelastic properties after baking, or combinations thereof, wherein the dough is a baked dough.

In accordance with an eighth aspect of the present disclosure, which may be used with any one or more of the preceding aspects in combination with the seventh aspect, the good viscoelastic properties of the dough allowing the dough to flow and to maintain a shape without deforming to an original shape or shrinking.

In accordance with an ninth aspect of the present disclosure, which may be used with any one or more of the preceding aspects in combination with the seventh aspect, the at least one enzyme is selected from the group consisting of α-amylase, β-amylase, γ-amylase, protease, or combinations thereof.

In accordance with a tenth aspect of the present disclosure, which may be used in combination with any one or more of the preceding aspects in combination with the seventh aspect, the at least one enzyme has an enzyme activity level of about 95° Litner.

In accordance with an eleventh aspect of the present disclosure, which may be used in combination with any one or more of the preceding aspects in combination with the seventh aspect, the dough includes malted barley flour in an amount from greater than 1% to about 5% by flour weight.

In accordance with a twelfth aspect of the present disclosure, which may be used with any one or more of the preceding aspects, the dough further includes at least one ingredient selected from the group consisting of flour, water, salt, sugar, yeast, or combinations thereof.

In accordance with a thirteenth aspect of the present disclosure, which may be used with any one or more of the preceding aspects, a dough includes malted barley flour in an amount greater than 1% to about 5% by flour weight, and the dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, or combinations thereof.

In accordance with an fourteenth aspect of the present disclosure, which may be used with any one or more of the preceding aspects in combination with the thirteenth aspect, the dough includes malted barley flour in an amount greater than 1% to about 3% by flour weight.

In accordance with a fifteenth aspect of the present disclosure, which may be used in combination with any one or more of the preceding aspects in combination with the thirteenth aspect, the dough includes malted barley flour in an amount of about 1.5% by flour weight.

In accordance with a sixteenth aspect of the present disclosure, which may be used with any one or more of the preceding aspects in combination with the thirteenth aspect, the dough further includes at least one ingredient selected from the group consisting of flour, water, salt, sugar, yeast, or combinations thereof.

In accordance with an seventeenth aspect of the present disclosure, which may be used with any one or more of the preceding aspects in combination with the thirteenth aspect, the malted barley flour includes at least one enzyme is selected from the group consisting of α-amylase, β-amylase, γ-amylase, protease, or combinations thereof.

In accordance with a eighteenth aspect of the present disclosure, which may be used in combination with any one or more of the preceding aspects in combination with the thirteenth aspect, the at least one enzyme may have an enzyme activity level from about 80° Litner to about 110° Litner.

In accordance with a nineteenth aspect of the present disclosure, which may be used in combination with any one or more of the preceding aspects in combination with the thirteenth aspect, the at least one enzyme has an enzyme activity level of about 95° Litner.

In accordance with a twentieth aspect of the present disclosure, which may be used with in combination with any one or more of the preceding aspects, a method of making a dough-based food product includes mixing a dough having malted barley flour in an amount greater than 1% to about 5.0% by flour weight, fermenting the dough for an amount of time between about 60 and about 120 minutes, and baking the dough to form the dough-based food product, and the dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, or combinations thereof.

In accordance with a twenty-first aspect of the present disclosure, which may be used with any one or more of the preceding aspects in combination with the twentieth aspect, the malted barley flour includes at least one enzyme is selected from the group consisting of α-amylase, β-amylase, γ-amylase, protease, or combinations thereof.

In accordance with a twenty-second aspect of the present disclosure, which may be used in combination with any one or more of the preceding aspects in combination with the twentieth aspect, the at least one enzyme may have an enzyme activity level from about 80° Litner to about 110° Litner.

In accordance with a twenty-third aspect of the present disclosure, which may be used in combination with any one or more of the preceding aspects in combination with the twentieth aspect, the at least one enzyme has an enzyme activity level of about 95° Litner.

In accordance with a twenty-fourth aspect of the present disclosure, which may be used with in combination with any one or more of the preceding aspects in combination with the twentieth aspect, the dough is fermented for about 90 minutes.

In accordance with a twenty-fifth aspect of the present disclosure, which may be used with in combination with any one or more of the preceding aspects in combination with the twentieth aspect, the dough is baked at an oven temperature from about 300° F. to about 800° F.

In accordance with a twenty-sixth aspect of the present disclosure, which may be used with in combination with any one or more of the preceding aspects in combination with the twentieth aspect, the dough is baked at an oven temperature of about 600° F.

In accordance with a twenty-seventh aspect of the present disclosure, which may be used with in combination with any one or more of the preceding aspects in combination with the twentieth aspect, the method further includes at least one step selected from the group consisting of sizing the dough into a dough billet after fermenting the dough, proofing the dough after sizing the dough, applying a dusting flour to the dough after pressing the dough, packaging the dough-based food product, or combinations thereof.

In accordance with a twenty-eighth aspect of the present disclosure, which may be used with in combination with any one or more of the preceding aspects, a method of making a dough-based food product includes mixing a dough having at least one enzyme having an enzyme activity level from about 80° Litner to about 110° Litner, wherein the enzyme activity level provides the dough with at least one characteristic selected from the group consisting of medium to high water absorption, medium fermentation after about 90 minutes, retention of gas cells after sizing the dough, or combinations thereof, and fermenting the dough for an amount of time between about 60 and about 120 minutes, and baking the dough to form the dough-based food product.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A dough comprising:
at least one enzyme comprising an enzyme activity level from about 80° Litner to about 110° Litner, wherein the enzyme level provides the dough with at least one characteristic selected from the group consisting of a water absorption ranging from about 58% to about 64%, a fermentation time from about 80 to about 100 minutes, retention of gas cells after sizing the dough, and combinations thereof; and
the dough is not baked.

2. The dough according to claim 1, wherein the water absorption is about 60%.

3. The dough according to claim 1, wherein the fermentation time is about 90 minutes.

4. A dough comprising:
at least one enzyme comprising an enzyme activity level from about 80° Litner to about 110° Litner, wherein the enzyme level provides the dough with at least one characteristic selected from the group consisting of retention of gas cells after sizing and/or baking the dough, good viscoelastic properties after baking the dough, and combinations thereof; and
the dough is a baked dough.

5. The dough according to claim 4, wherein the good viscoelastic properties of the dough allow the dough to flow and to maintain a shape without deforming to an original shape or shrinking.

6. The dough according to claim 1, wherein the dough comprises malted barley flour in an amount greater than 1% to about 5% by flour weight.

7. The dough according to claim 1, wherein the at least one enzyme is selected from the group consisting of α-amylase, β-amylase, γ-amylase, protease, and combinations thereof.

8. The dough according to claim 1, wherein the at least one enzyme comprises an enzyme activity level of about 95° Litner.

9. A dough comprising:
malted barley flour in an amount greater than 1% to about 5% by flour weight, wherein the dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, and combinations thereof.

10. The dough according to claim 9, wherein the malted barley flour comprises at least one enzyme selected from the group consisting of α-amylase, β-amylase, γ-amylase, protease, and combinations thereof.

11. The dough according to claim 10, wherein the at least one enzyme comprises an enzyme activity level from about 80° Litner to about 110° Litner.

12. A method of making a dough-based food product, the method comprising:
mixing a dough having malted barley flour in an amount greater than 1% to about 5.0% by flour weight, wherein the dough is selected from the group consisting of white bread dough, hearth bread dough, dark bread dough, sweet bread dough, roll dough, cracker dough, bagel dough, biscuit dough, pizza dough, whole grain dough, flat bread dough, pita dough, and combinations thereof;
fermenting the dough for an amount of time between about 60 and about 120 minutes; and
baking the dough to form the dough-based food product.

13. The method according to claim 12, wherein the malted barley flour comprises at least one enzyme selected from the group consisting of α-amylase, β-amylase, γ-amylase, protease, and combinations thereof.

14. The method according to claim 13, wherein the at least one enzyme comprises an enzyme activity level from about 80° Litner to about 110° Litner.

15. The method according to claim 12, wherein the dough is baked at an oven temperature from about 300° F. to about 800° F.

16. The method according to claim 12 comprising at least one step selected from the group consisting of sizing the dough into a dough billet after fermenting the dough, proofing the dough after sizing the dough, applying a dusting flour to the dough after pressing the dough, packaging the dough-based food product, and combinations thereof.

17. The dough according to claim 4, wherein the dough comprises malted barley flour in an amount greater than 1% to about 5% by flour weight.

18. The dough according to claim 4, wherein the at least one enzyme is selected from the group consisting of α-amylase, β-amylase, γ-amylase, protease, and combinations thereof.

19. The dough according to claim 4, wherein the at least one enzyme comprises an enzyme activity level of about 95° Litner.
